(19) United States
(12) Patent Application Publication
(10) Pub. No.: US 2007/0010251 A1
(43) Pub. Date: Jan. 11, 2007

(54) System and method for performing handover between frequency assignments in a communication system

(75) Inventors: Jae-Hee Cho, Seoul (KR); Soon-Young Yoon, Seoul (KR); Young-Hoon Kwon, Seongnam-si (KR); Jang-Hoon Yang, Seongnam-si (KR); In-Seok Hwang, Seoul (KR); Joong-Ho Jeong, Seoul (KR); Kyung-Joo Suh, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS., LTD., Suwon-si (KR)

(21) Appl. No.: 11/483,484

(22) Filed: Jul. 10, 2006

(30) Foreign Application Priority Data
Jul. 8, 2005 (KR) 2005-61673

(51) Int. Cl. H04Q 7/20

(52) U.S. Cl. 455/436

(57) ABSTRACT

A method and system for performing an inter-FA handover in a communication system are provided. An MS receives from a serving BS neighbor BS information including a BS ID of at least one neighbor BS and a reference signal index of a reference signal used in the at least one neighbor BS. When it is necessary to scan the reference signal from the at least one neighbor BS, the MS scans the reference signal corresponding to the reference signal index. If the scanned reference signal has a quality equal to or greater than a threshold, the MS determines the BS ID of the at least one neighbor BS using the reference signal index as a BS ID for a recommended neighbor BS available for the inter-FA handover.

### PRIORITY

This application claims priority under 35 U.S.C. § 119 to an application entitled “System and Method for Performing Handover Between Frequency Assignments in a Communication System” filed in the Korean Intellectual Property Office on Jul. 8, 2005 and assigned Serial No. 2005-61673, the contents of which are incorporated herein by reference.

### BACKGROUND OF THE INVENTION

1. Field of the Invention

The present invention relates generally to a communication system, and in particular, to a system and method for performing a handover between base stations (BSs) using different frequency assignments (FAs) in a communication system.

2. Description of the Related Art

Studies have actively been conducted on high-speed, large-data transmission/reception for mobile stations (MSs) in future-generation communication systems. A major future-generation communication system is based on the Institute of Electrical and Electronics Engineers (IEEE) 802.16e standard.

FIG. 1 illustrates the configuration of a typical IEEE 802.16e communication system.

Referring to FIG. 1, the IEEE 802.16e communication system is designed on a multi-cell structure. The IEEE 802.16e communication system includes cells 100 and 150, BSs 110 and 140 for managing the cells 100 and 150, respectively, and a plurality of MSs 111, 113, 130, 151 and 153. While one BS may manage a plurality of cells, it is assumed herein for notational simplicity that one BS manages one cell. The MS 130 is located at a boundary between the cells 100 and 150, i.e. in a handover region. When the MS 130 moves into cell 150 during signal transmission/reception to/from the BS 110, the serving BS of the MS 130 is changed from BS 110 to BS 140.

FIG. 2 is a diagram illustrating a signal flow for an MS-initiated handover procedure in the typical IEEE 802.16e communication system.

Referring to FIG. 2, a first BS 210 being a serving BS sends a Mobile Neighbor Advertisement (MOB_NBR_ADV) message to an MS 200 in step 211. The format of the MOB_NBR_ADV message is illustrated in Tables 1A, 1B and 1C.

TABLE 1A

| | Size | |
|---|---|---|
| Syntax | (bits) | Notes |
| MOB_NBR_ADV_Message_Format( ) { | — | — |
| Management Message Type=53 | 8 | — |
| Skip-Optional_Fields bitmap | 8 | Bit[0]: if set to 1, omit Operator ID field |
| | | Bit[1]: if set to 1, omit NBR BS ID field |
| | | Bit[2]: if set to 1, omit HO process optimization |
| | | field |
| | | Bit[3]: if set to 1, omit QoS related fields |
| | | Bit[4]-[7]: reserved |
| If(Skip-Optional-Fields-[0]=0) { | — | — |
| Operator ID | 24 | Unique ID assigned to the operator |
| } | — | — |
| Configuration Change Count | 8 | Incremented each time the information for the |
| | | associated neighbor BS has changed. |
| Fragmentation Index | 4 | Indicates the current fragmentation index. |
| Total Fragmentation | 4 | Indicates the total number of fragmentations. |
| N_NEIGHBORS | 8 | — |
| For(j=0;j<N_NEIGHBORS;j++) { | — | — |
| Length | 8 | Length of message information within the |
| | | iteration of N_NEIGHBORS in bytes. |
| PHY Profile ID | | Aggregated IDs of Co-located FA Indicator, FA |
| | | Configuration Indicator, FFT size, Bandwidth, |
| | | Operation Mode of the starting |
| | | subchannelization of a frame, and channel |
| | | Number |
| if(FA Index Indicator ==1) { | — | — |
| FA Index | 8 | This field, Frequency Assignment Index, is |
| | | present only the FA Index Indicator in PHY |
| | | Profile ID is set. Otherwise, the neighbor BS has |
| | | the same FA Index or the center frequency is |
| | | indicated using the TLV encoded information. |
| } | — | — |
| if(BS EIRP Indicator ==1) { | — | — |
| BS EIRP | 8 | Signed Integer from−128 to 127 in unit of dBm. |
| | | This field is present only if the BS EIRP |
| | | indicator is set in PHY Profile ID. Otherwise, the |
| | | BS has the same EIRP as the serving BS. |
| } | — | — |
| if(Skip-Optional-Fields[1]=0) { | — | — |
| Neighbor BSID | 24 | This is an optional field OFDMA PHY and it is |
| | | omitted or skipped is Skip Optional Fields Flag = 1 |

TABLE 1B

| | | |
|---|---|---|
| } | — | — |
| Preamble Index/Subchannel Index | 8 | For the SCa and OFDMA PHY this parameter |
| | | defines the PHY specific preamble. For the |
| | | OFDM PHY the 5 LSB contain the active DL |
| | | subchannel index. The 3 MSB shall be Reserved |
| | | and set to ‘0b000’. |
| if(Skip-Optional-Fields[2]=0) { | — | — |
| HO Process Optimization | 8 | HO Process Optimization is provided as part of |
| | | this message is indicative only. HO process |
| | | requirements may change at time of actual HO. |
| | | For each Bit location, a value of ‘0’ indicates the |
| | | associated reentry management messages shall |
| | | be required, a value of ‘1’ indicates the reentry |
| | | management message may be omitted. |
| | | Regardless of the HO Process Optimization TLV |
| | | settings, the target BS may send unsolicited |
| | | SBC-RSP and/or REG-RSP management |
| | | messages. |
| | | Bit #0; Omit SBC-REQ/RSP management |
| | | messages during re-entry processing |
| | | Bit#1; Omit PKM Authentication phase except |
| | | TEK phase during current re-entry processing |
| | | Bit#2; Omit PKM TEK creation phase during |
| | | reentry processing |
| | | Bit#3; Omit REG-REQ/RSP management during |
| | | current re-entry processing |
| | | Bit#4; Omit Network Address Acquisition |
| | | management messages during current reentry |
| | | processing |
| | | Bit#5; Omit Time of Day Acquisition |
| | | management messages during current reentry |
| | | processing |
| | | Bit#6; Omit TFTP management messages during |
| | | current re-entry processing |
| | | Bit#7; Full service and operational state transfer |
| | | or sharing between serving BS and target BS |
| | | (ARQ, timers, counters, MAC state machines, |
| | | etc...) |
| } | — | — |
| if(Skip-Optional-Fields[3]=0) { | — | — |
| Scheduling Service Supported | 4 | Bitmap to indicate if BS supports a particular |
| | | scheduling service. 1 indicates support, 0 |
| | | indicates not support; |
| | | bit 0; Unsolicited Grant Service (UGS) |
| | | bit 1; Real-time Polling Service (rtPS) |
| | | bit 2; Non-real-time Polling service (nrtPS) |
| | | bit 3; Best Effort value of 0b0000 indicates no |
| | | information on service available. |

TABLE 1C

| | | |
|---|---|---|
| Available Radio Resource | 4 | Percentage of reported average available |
| | | subchannels and symbols resources per frame |
| | | 0b0000: 0% |
| | | 0b0001: 20% |
| | | 0b0010: 40% |
| | | 0b0011: 60% |
| | | 0b0100: 80% |
| | | 0b0101: 100% |
| | | 0b0110-0b1110: reserved |
| | | 0b0110-0b1110: reserved |
| | | value of ‘0b1111’ indicates no information on |
| | | service available |
| } | — | — |
| DCD Configuration Change Count | 4 | This represents the 4 LSBs of the Neighbor BS |
| | | current DCD configuration change count |
| UCD Configuration Change Count | 4 | This represents the 4 LSBs of the Neighbor BS |
| | | current UCD configuration change count |
| TLV Encoded Neighbor information | variable | TLV specific |
| } | — | — |
| } | — | — |

Referring to FIGS. 1A, 1B and 1C, the MOB_NBR_ADV message includes a plurality of Information Elements (IEs) which are Management Message Type indicating the type of the transmission message, Operator ID indicating a network Identifier (ID), N_NEIGHBORS indicating the number of neighbor BSs, Neighbor BS-ID identifying the neighbor BSs, Preamble Index used in a corresponding neighbor BS, and FA index representing a physical channel number of the neighbor BS.

The MS 200 can acquire information about neighbor BSs from the MOB_NBR_ADV message. To scan the quality of reference signals such as preamble signals from the neighbor BSs, for example, Carrier-to-Interference and Noise Ratios (CINRs), the MS 200 sends a Mobile Scanning Interval Allocation Request (MOB_SCN_REQ) message to the first BS 210 in step 213. The MOB_SCN_REQ message has the following configuration shown in Table 2.

TABLE 2

| Syntax | Size | Notes |
|---|---|---|
| MOB-SCN-REQ_Message_Format( ) { | | |
| Management Message Type=50 | 8 bits | |
| Scan Duration | 12 bits | Units are frames. |
| reserved | 4 bits | |
| } | | |

Referring to Table 2, the MOB_SCN_REQ message includes the IEs of Management Message Type indicating the type of the transmission message and Scan Duration indicating a scan duration for which the MS 200 intends to scan the CINRS of the preamble signals from the neighbor BSs. The Scan Duration is expressed in units of frames. The time when the MS 200 requests scanning interval allocation has no direct relation to the CINR scanning and thus its detailed description is not provided herein.

Meanwhile, upon receipt of the MOB_SCN_REQ message, the first BS 210 sends a Mobile Scanning Interval Allocation Response (MOB_SCN_RSP) message including scanning information and allocating a non-zero scan duration to the MS 200 in step 215. The MOB_SCN_RSP message is configured as follows and shown in Table 3.

TABLE 3

| Syntax | Size | Notes |
|---|---|---|
| MOB-SCN-RSP_Message_Format( ) { | | |
| Management Message Type=51 | 8 bits | |
| CID | 16 bits | basic CID of the MS |
| Duration | 12 bits | in frames |
| Start Frame | 4 bits | |
| } | | |

Referring to Table 3, the IEs of the MOB_SCN_RSP message include Management Message Type indicating the type of the transmission message, Connection ID (CID) indicating the CID of the MS 200 that has sent the MOB_SCN_REQ message, Duration indicating a scan duration, and Start Frame indicating the start of scanning. The scan duration is a time of period for which the MS 200 scans the CINRs of the preamble signals from the neighbor BSs. If the scan duration is 0, this implies that the first BS 210 has rejected the scan duration allocation request.

In step 217, the MS 200 scans the CINRs of the preamble signals from the neighbor BSs set in the MOB_NBR_ADV message during the scan duration set in the MOB_SCN_RSP message.

After the CINR scanning, when the MS 200 decides to change its serving BS from the first BS 210 to another BS in step 219, MS 200 sends a Mobile Station HandOver Request (MOB_MSHO_REQ) message to the first BS 210 in step 221. A candidate BS to be a serving BS for the MS 200 after handover is called a target BS. The MOB_MSHO_REQ message has the following format shown in Table 4.

TABLE 4

| Syntax | Size | Notes |
|---|---|---|
| MOB-MSHO-REQ_Message_Format( ) { | | |
| Management Message Type=53 | 8 bits | |
| For (i=0; j<N_Recommended; j++) { | | N_Recommended can be derived from the |
| | | known length of the message |
| Neighbor BS_ID | 48 bits | |
| BS CINR mean | 8 bits | |
| Service level prediction | 8 bits | |
| } | | |
| Estimated HO start | 8 bits | The estimated HO time shall be the time for the |
| | | recommended target BS. |
| } | | |

Referring to Table 4, the MOB_MSHO_REQ message includes the IEs of Management Message Type indicating the type of the transmission message and the results of the scanning. N_Recommended indicates the number of neighbor BSs that send preamble signals with CINRs equal to or greater than a predetermined threshold, i.e. the number of neighbor BSs recommended for handover. Hereinafter, these neighbor BSs are called recommended neighbor BSs. The MOB_MSHO_REQ message further includes Neighbor BS-ID identifying each recommended neighbor BS, BS CINR mean indicating the average CINR of the preamble signal from the recommended neighbor BS, Service level prediction indicating a service level at which the recommended neighbor BS is expected to service the MS 200, and Estimated HO Start indicating an estimated HO time for the recommended neighbor BS.

Upon receipt of the MOB_MSHO_REQ message, the first BS 210 detects a list of recommended neighbor BSs for the handover of the MS 200 from the N_Recommended information set in the MOB_MSHO_REQ message in step 223. In the illustrated case of FIG. 2, the recommended neighbor BS list includes a second BS 220 and a third BS 230. The first BS 210 sends a HO_PRE_NOTIFICATION message to the second and third BSs 220 and 230 in steps 224 and 227, respectively. The HO_PRE_NOTIFICATION message is formatted as follows and as shown in Table 5.

TABLE 5

| Field | Size | Notes |
|---|---|---|
| Global Header | 152-bit | |
| For(j=0;j<Num Records; j++) { | | |
| MS unique identifier | 48-bit | 48-bit unique identifier used by MS (as |
| | | provided by the MS or by the I-am-host-of |
| | | message) |
| Estimated Time to HO | 16-bit | In milliseconds, relative to the time stamp. A |
| | | value of 0 indicates that the estimated time is |
| | | unknown. |
| Required BW | 8-bit | Bandwidth which is required by MS (to |
| | | guarantee minimum packet data |
| | | transmission) |
| For (i=0; i<Num_SFID_Records; i++) { | | |
| SFID | 32 bits | |
| For (i=0; i<Num_QoS_Records; i++) { | | |
| Required QoS | Variable | 11-13 QoS Parameter definition encodings |
| | | that in combination define an |
| | | AdmittedQoSParamSet specific to the SFID |
| } | | |
| } | | |
| } | | |
| Security field | TBD | A means to authenticate this message |

Referring to Table 5, the HO_PRE_NOTIFICATION message has Global Header included commonly in messages between BSs in a backbone network, MS unique ID identifying the MS 200 to be handed over to the second or third 10 MS 220 or 230, Estimated Time to HO indicating an estimated handover start time for the MS 200, Required BW indicating a bandwidth that the MS 200 requests to a target BS, Service Flow Identifier (SFID) identifying a service flow being serviced to the MS 200, and Required Quality of Service (QoS) indicating a QoS level for each SFID. The required BW and required QoS are identical to the service level prediction set in the MOB_MSHO_REQ message illustrated in Table 4.

The Global Header common to messages including the HO_PRE_NOTIFICATION message exchanged between BSs within the same backbone network has the following configuration shown in Table 6.

TABLE 6

| Field | Size | Notes |
|---|---|---|
| Message Type=? | 8-bit | |
| Sender BS-ID | 48-bit | Base station unique identifier |
| | | (Same number as that broadcasted |
| | | on the DL_MAP message) |
| Target BS-ID | 48-bit | Base station unique identifier |
| | | (Same number as that broadcasted |
| | | on the DL_MAP message) |
| Time stamp | 32-bit | Number of milliseconds since midnight |
| | | GMT (set to 0xffffffff to ignore) |
| Num Records | 16-bit | Number of MS identity records |

Referring to Table 6, the Global Header includes a plurality of IEs. The IEs include Message Type indicating the type of the transmission message, Sender BS-ID identifying the BS that transmits this message, Target BS-ID to receive the message, a Time Stamp, and Num Records indicating the number of MS records set in the message.

The second and third BSs 220 and 230 each reply with an HO_PRE_NOTIFICATION_RESPONSE message in steps 229 and 231. The HO_PRE_NOTIFICATION_RESPONSE message is configured as illustrated in Table 7.

TABLE 7

| Field | Size | Notes |
|---|---|---|
| Global Header | 152-bit | |
| For (j=0; j<Num Records; j++) { | | |
| MS unique identifier | 48-bit | 48-bit unique identifier used |
| | | by MS (as provided by the |
| | | MS or by the I-am-host-of |
| | | message) |
| BW Estimated | 8-bit | Bandwidth which is provided |
| | | by BS (to guarantee |
| | | minimum packet data |
| | | transmission) |
| | | TBD how to set this field |
| QoS Estimated | 8-bit | Quality of Service level |
| | | Unsolicited Grant Service |
| | | (UGS) |
| | | Real-time Polling Service |
| | | (rtPS) |
| | | Non-real-time Polling |
| | | Service (nrtPS) |
| | | Best Effort |
| } | | |
| Security field | TBD | A means to authenticate this |
| | | message |

Referring to Table 7, the HO_PRE_NOTIFICATION_RESPONSE message includes the IEs of Global Header set commonly in messages exchanged between BSs in a backbone network, MS unique ID identifying the MS 200, BW Estimated indicating a bandwidth that the second and third BSs 220 and 230 each are expected to provide, and QoS Estimated indicating a QoS level that the second and third BSs 220 and 230 each are expected to provide.

Meanwhile, the first BS 210 analyzes the received HO_PRE_NOTIFICATION_RESPONSE messages and orders the recommended neighbor BSs in the order of bandwidth and QoS level closest to the bandwidth and QoS level requested by the MS 200. In the illustrated case of FIG. 2, the third and second BSs 230 and 220 in this order can provide an optimum bandwidth and QoS to the MS 200. While the first BS 210 orders all recommended neighbor BSs, i.e. the second and third BSs 220 and 230, it may select some of the neighbor BSs recommended by the MS 200 and order the selected recommended neighbor BSs. The ordered recommended neighbor BSs are called recommended target BSs.

In step 233, the first BS 210 sends a Mobile BS HandOver Response (MOB_BSHO_RSP) message including information about the recommended target BSs to the MS 200. The MOB_BSHO_RSP is configured as illustrated in Table 8 below.

TABLE 8

| Syntax | Size | Notes |
|---|---|---|
| MOB-BSHO-RSP_Message_Format( ) { | | |
| Management Message Type=54 | 8 bits | |
| Estimated HO start | 8 bits | |
| For (j=0;j<N_Recommended;j++) { | | Neighbor base stations shall be presented in an |
| | | order such that the first presented is the one most |
| | | recommended and the last presented is the least |
| | | recommended. |
| | | N_Recommended can be derived from the known |
| | | length of the message |
| Neighbor BS-ID | 48 bits | |
| service level prediction | 8 bits | |
| } | | |
| } | | |

In Table 8, the MOB_BSHO_RSP message includes a plurality of IEs. The IEs include Management Message Type indicating the type of the transmitted message, Estimated HO start indicating an estimated time when the handover will start, and information about the recommended target BSs ordered by the first BS 210. N_Recommended indicates the number of the recommended target BSs, Neighbor BS-ID identifies each of the recommended target BSs, and service level prediction indicates an expected service level that the recommended target BS will provide to the MS 200.

The MS 200 analyzes N_Recommended information included in the MOB_BSHO_RSP message and selects a final target BS. It is assumed that the MS 200 selects the third BS 230 as the final target BS. The MS 200 then sends a Mobile HandOver Indication (MOB_HO_IND) message to the first BS 210 in step 235. The MOB_HO_IND message has the following format illustrated in Table 9.

TABLE 9

| Syntax | Size | | Notes |
|---|---|---|---|
| MOB_HO_IND_Message_Format( ) { | | | |
| Management Message Type=56 | 8 | bits | |
| reserved | 6 | bits | Reserved; shall be set to zero |
| HO_IND_type | 2 | bits | 00: Serving BS release |
| | | | 01: HO cancel |
| | | | 10: HO reject |
| | | | 11: reserved |
| Target_BS_ID | 48 | bits | Applicable only when HO_IND-type is set to 00. |
| HMAC Tuple | 21 | bytes | See 11.4.11 |
| } | | | |

In Table 9, the MOB_HO_IND message includes a plurality of IEs. The IEs include Management Message Type indicating the type of the transmitted message, HO_IND_type indicating whether the MS 200 has decided handover to the final target BS, cancelled the handover, or rejected the handover, Target_BS_ID identifying the final target BS if the handover has been decided, Hashed Message Authentication Code (HMAC) Tuple used to authenticate the MOB_HO_IND message. For handover to the final target BS, HO_IND_type=00, for handover cancellation, HO_IND_type=01, and for handover rejection, HO_IND_type=10. When receiving the MOB_HO_IND message with HO_IND_type=10, the first BS 210 selects new recommended target BSs and re-sends the MOB_BSHO_RSP message to the MS 200.

When receiving the MOB_HO_IND message with HO_IND_type=00, the first BS 210 releases a connection from the MS 200 or maintains the connection for a predetermined time until being notified of handover completion from the final target BS, i.e. the third BS 230, determining that the MS 200 will perform a handover to the third BS 230 in step 237. In this way, after sending the MOB_HO_IND message to the first BS 210, the MS 200 performs the handover to the third BS 230.

FIG. 3 is a diagram illustrating a signal flow for a BS-initiated handover procedure in the typical IEEE 802.16e communication system. To distribute its heavy load to neighbor BSs or adapt to a change in the uplink status of an MS, a BS initiates a handover.

Referring to FIG. 3, a first BS 310 being a serving BS sends a MOB_NBR_ADV message to an MS 300 in step 311. The MS 300 acquires information about neighbor BSs from the MOB_NBR_ADV message.

When a handover is required for the MS 330 under management of the first BS 310 in step 313, the first BS 310 sends a HO_PRE_NOTIFICATION message to the neighbor BSs in steps 315 and 317. The HO_PRE_NOTIFICATION message contains information about bandwidth and service level requirements that a target BS to be a new serving BS for the MS 300 has to fulfill. In the illustrated case of FIG. 3, the neighbor BSs of the first BS 310 are second and third BSs 320 and 330.

The second and third BSs 320 and 330 reply with HO_PRE_NOTIFICATION_RESPONSE messages to the first BS 310 in step 319 and 321. The HO_PRE_NOTIFICATION_RESPONSE messages each include an ACKnowledgement/Non-ACKnowledgement (ACK/NACK) signal indicating whether the requested handover can be accepted or not, and a bandwidth and service level available to the MS 300.

The first BS 310 selects recommended target BSs supporting the bandwidth and service level requested by the MS 300 and arranges the recommended target BSs in the order of bandwidth and service level closest to the MS-requested bandwidth and service level. In FIG. 3, it is assumed that the third and second BSs 330 and 320 in this order optimally support the requested bandwidth and service level.

The first BS 310 sends a Mobile BS HandOver Request (MOB_BSHO_REQ) message including information about the recommended target BSs to the MS 300 in step 323. The MOB_BSHO_REQ message has the following configuration illustrated in Table 10.

TABLE 10

| Syntax | Size | Notes |
|---|---|---|
| MOB_BSHO_REQ_Message_Format( ) { | | |
| Management Message Type=52 | 8 bits | |
| For (i=0; j<N_Recommended; j++) { | | N_Recommended can be derived |
| | | from the known length of the message |
| Neighbor BS-ID | 48 bits | |
| Service level prediction | 8 bits | |
| } | | |
| } | | |

In Table 10, the MOB_BSHO_REQ message has a plurality of IEs. The IEs include Management Message Type indicating the type of the transmitted message and information about the recommended target BSs. N_Recommended indicates the number of the recommended target BSs, Neighbor BS-ID identifies each of the recommended target BSs, and service level prediction indicates an expected service level that the recommended target BS will support for the MS 300.

Determining from the MOB_BSHO_REQ message that the first BS 310 requests a handover, the MS 300 selects a final target BS for the handover based on N_Recommended information set in the received message. To select the final target BS, the MS 300 needs to scan the CINRs of preamble signals from the recommended target BSs. Therefore, the MS 300 sends a MOB_SCN_REQ message to the first BS 310 in step 325. The time when the MS 300 requests scanning interval allocation has no direct relation to the CINR scanning and thus its detailed description is not provided herein.

Meanwhile, upon receipt of the MOB_SCN_REQ message, the first BS 310 sends an MOB_SCN_RSP message to the MS 300 in step 327. In step 329, the MS 300 scans the CINRs of the preamble signals from the neighbor BSs set in the MOB_NBR_ADV message and from the recommended target BSs set in the MOB_BSHO_REQ message during a scan duration set in the MOB_SCN_RSP message.

After the CINR scanning, the MS 300 sends an MS HandOver Response (MOB_MSHO_RSP) message including information about the recommended target BSs according to the CINR scanning results to the first BS 310 in step 331. The MOB_MSHO_RSP message has the following format shown in Table 11.

TABLE 11

| Syntax | Size | Notes |
|---|---|---|
| MOB_MSHO_RSP_Message_Format( ) { | | |
| Management Message Type=54 | 8 bits | |
| Estimated Ho time | 8 bits | |
| For (i=0; j<N_Recommended; j++) { | | N_Recommended can be derived from the |
| | | known length of the message |
| Neighbor BS-ID | 48 bits | |
| BS S/(N+1) | 8 bits | |
| } | | |
| } | | |

In Table 11, the MOB_MSHO_RSP message has a plurality of IEs. The IEs include Management Message Type indicating the type of the transmitted message, Estimated HO time indicating an estimated HO time at which the handover will start, and the CINR scanning results of the recommended target BSs. N_Recommended indicates the number of the recommended target BSs, Neighbor BS-ID identifying each recommended target BS, and BS S/(N+1) indicating the CINR scanning result of a preamble signal from the recommended target BS.

The MS 300 selects a final target BS among the recommended target BSs and sends a MOB_HO_IND message to the first BS 310, notifying of a handover to the final target BS in step 333. Determining that the MS 300 will perform a handover to the final target BS, the first BS 310 releases a connection from the MS 300 or maintains the connection for a predetermined time until being notified of handover completion from the final target BS, i.e. the third BS 330 in step 335. In this way, after sending the MOB_HO_IND message to the first BS 310, the MS 300 performs the handover to the third BS 330.

### SUMMARY OF THE INVENTION

As described above, the IEEE 802.16e communication system specifies the MS-initiated and BS-initiated handover procedures. Yet, these handover procedures give no consideration to the FAs of BSs. Accordingly, there exists a need for developing a handover scheme that considers the FAs of BSs in the IEEE 802.16e communication system.

An object of the present invention is to substantially solve at least the above problems and/or disadvantages and to provide at least the advantages below. Accordingly, the present invention provides a system and method for performing a handover that takes into account the FA in a communication system.

The present invention also provides a system and method for performing a handover between BSs using different FAs in a communication system.

According to one aspect of the present invention, in a method of performing an inter-FA handover in an MS in a communication system, the MS receives from a serving BS neighbor BS information including a BS ID of at least one neighbor BS and a reference signal index of a reference signal used in the at least one neighbor BS. When it is necessary to scan the reference signal from the at least one neighbor BS, the MS scans the reference signal corresponding to the reference signal index. If the scanned reference signal has a quality equal to or greater than a threshold, the MS determines the BS ID of the at least one neighbor BS using the reference signal index as a BS ID for a recommended neighbor BS available for the inter-FA handover.

According to another aspect of the present invention, in a method of performing an inter-FA handover in a CO (Central Office) in a communication system, the CO controls a serving BS to broadcast neighbor BS information including a BS ID of at least one neighbor BS using at least one active FA and a reference signal index of a reference signal used in the at least one neighbor BS. The CO controls the serving BS to send a reference signal with the reference signal index on the active FA and a reference signal with the reference signal index on at least one inactive FA.

According to a further aspect of the present invention, in a method of performing an inter-FA handover in a communication system, a CO controls a serving BS to broadcast neighbor BS information including a BS ID of at least one neighbor BS using at least one active FA and a reference signal index of a reference signal used in the at least one neighbor BS, and controls the serving BS to send a reference signal with the reference signal index on the active FA, and a reference signal with the reference signal index on at least one inactive FA. An MS receives the neighbor BS information from the serving BS. When the reference signal from the at least one neighbor BS is to be scanned, the MS scans the reference signal corresponding to the reference signal index. If the scanned reference signal has a quality equal to or greater than a threshold, the MS determines the BS ID of the at least one neighbor BS using the reference signal index as a BS ID for a recommended neighbor BS available for the inter-FA handover.

According to still another aspect of the present invention, a system for performing an inter- FA handover in a communication system includes an MS, a serving BS, at least one neighbor BS using at least one active FA, and a central office. The central office controls the serving BS to broadcast neighbor BS information including a BS ID of the at least one neighbor BS and a reference signal index of a reference signal used in the at least one neighbor BS, and controls the serving BS to send a reference signal with the reference signal index on the active FA, and a reference signal with the reference signal index on at least one inactive FA.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical IEEE 802.16e communication system;

FIG. 2 is a diagram illustrating a signal flow for an MS-initiated handover procedure in the typical IEEE 802.16e communication system;

FIG. 3 is a diagram illustrating a signal flow for a BS-initiated handover procedure in the typical IEEE 802.16e communication system;

FIG. 4 illustrates an inter-FA handover in an IEEE 802.16e communication system according to the present invention;

FIG. 5 is a block diagram of a BS in the IEEE 802.16e communication system according to an embodiment of the present invention;

FIG. 6 is a block diagram of a BS in the IEEE 802.16e communication system according to another embodiment of the present invention;

FIG. 7 is a block diagram of a BS in the IEEE 802.16e communication system according to a third embodiment of the present invention; and

FIG. 8 is a flowchart illustrating an MS operation for performing an inter-FA handover in the IEEE 802.16e communication system according to the present invention.

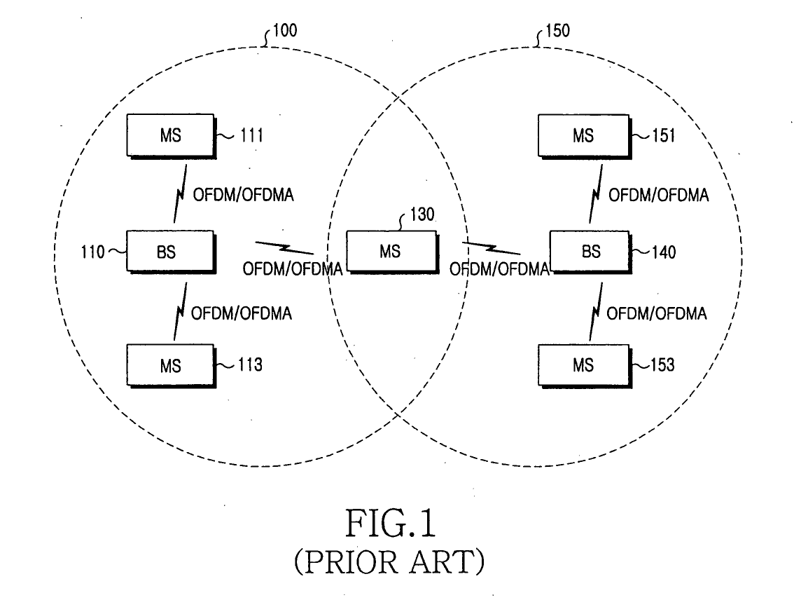

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a system and method for performing a handover between BSs using different frequency assignments (FAs) in a communication system, for example, an Electrical and Electronics Engineers (IEEE) 802.16e communication system. The present invention also provides a system and method for performing a seamless handover between base stations(BSs) using different FAs without setting a specific scanning interval and thus without any disconnection from a serving BS. While the present invention is described in the context of the IEEE 802.16e communication system, for convenience sake, it is to be clearly understood that the present invention is applicable to any other communication system. In the following description, BSs use omni-directional antennas, to which the present invention is not limited. Therefore, the present invention also applies to BSs using a sectorized antenna structure. One thing to note herein is that the terms “scanning interval” and “scan duration” are interchangeably used.

In the IEEE 802.16e communication system, there are two types of handover depending on whether a serving BS and a target BS use the same or different FAs: intra-FA handover and inter-FA handover, respectively. The intra-FA handover takes place within the same FA, whereas the inter-FA handover takes place between different FAs.

The inter-FA handover is triggered in the following cases in the IEEE 802.16e communication system.

(1) While a BS using the same FA exists in a neighbor Central Office (CO), sufficient resources are not available for allocation to a handover mobile station(MS).

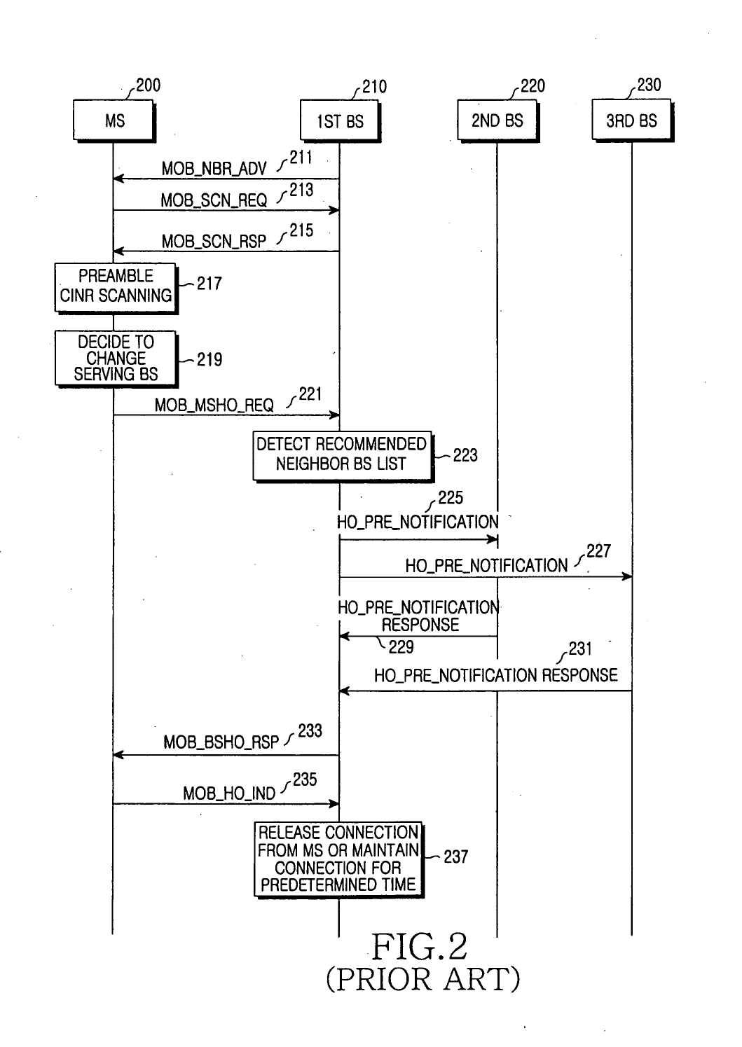

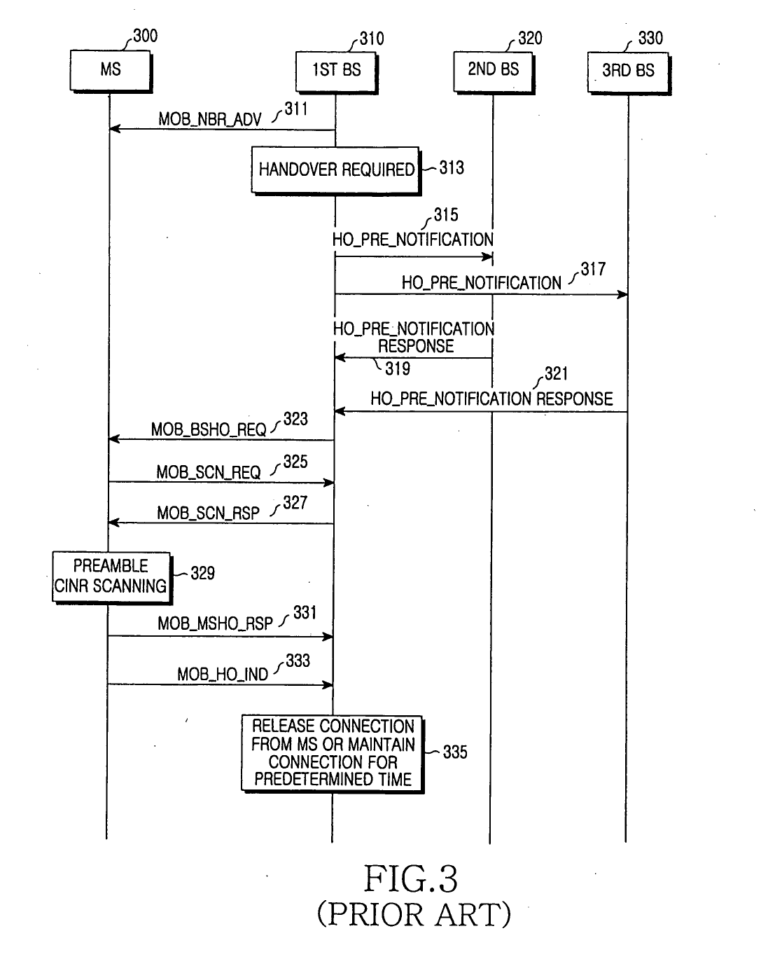

(2) Because there is no BS using the same FA in a neighbor CO, an on-going service cannot be provided with a handover to a corresponding FA. The MS can determine from neighbor BS information acquired from a Mobile Neighbor Advertisement (MOB_NBR_ADV) message whether an inter-FA handover is likely to take place due to the absence of a BS using the same FA in a neighbor CO. The IEEE 802.16e communication system can allocate different BS Identifiers (IDs) to different BSs. The BS ID of each BS is decided irrespective of the FA of the BS. The serving BS and the target BS in the conventional MS-initiated and BS-initiated handover procedures illustrated in FIGS. 2 and 3 can be distinguished from each other by their BS IDs. Therefore, if the BS IDs of the serving BS and the target BS can be detected, the handover procedures illustrated in FIGS. 2 and 3 can be applied to the intra- and inter-FA handovers.

For the intra-FA handover, a technique for increasing the efficiency of the handover illustrated in FIGS. 2 and 3 may be considered. For this purpose, scanning of the quality of reference signals (e.g. preamble signals) represented by Carrier-to-Interference and Noise Ratio(CINR), for example, will be described.

An MS acquires information about neighbor BSs from a MOB_NBR_ADV message broadcast by a serving BS. The MS then is allocated a scan duration from the serving BS by exchanging a Mobile Scanning Interval Allocation Request (MOB_SCN_REQ) message and a Mobile Scanning Interval Allocation Response (MOB_SCN_RSP) message with the serving BS. During the scan duration, the MS discontinues communications with the serving BS and scans the CINRS of preamble signals from the neighbor BSs. Specifically, the MS performs the CINR scanning in accordance with the BS IDs, FAs and preamble indexes of the neighbor BSs, FAs acquired from the MOB_NBR_ADV message.

The IEEE 802.16e communication system provides a plurality of different preamble sequences having unique preamble indexes. It is to be noted that the preamble indexes are not IDcells defined by the general IEEE 802.16e communication standard. Thus, each BS is allocated one preamble index and this preamble index information is sent to the MS by the MOB_NBR_ADV message. The MS measures the CINRs of the preamble signals from the neighbor BSs based on their FAs and preamble indexes. If the CINRs of neighbor BSs are equal to or greater than a threshold, the MS registers the BS IDs of the neighbor BSs in a recommended neighbor BS list from which to select a final target BS.

For efficient preamble CINR scanning for the intra-FA handover, the following scheme can be contemplated.

A drawback with the above-described preamble CINR scanning is that communications between the MS and the serving BS are disconnected during the scan duration. A signal received at the MS includes preamble signals from the serving BS and neighbor BSs using the same FA as that of the serving BS according to the principle of linear overlap. Therefore, it is possible for the MS to continue preamble CINR scanning for the neighbor BSs without defining a specific scan duration by use of a predetermined signal processing device.

That is, preamble signals from BSs using different FAs within the same CO are propagated to the MS in the same path. Preamble signals from BSs located in different COs are also received at the MS in the same propagation path. In this case, the CINR measurement of the preamble signal from the serving BS is almost equal over all FAs. Since the IEEE 802.16e communication system is a broadband communication system, a CINR difference arising from the frequency difference between FAs is negligibly small. As a consequence, for handover, the MS simultaneously scans only the FA of the serving BS using the predetermined device instead of performing preamble CINR scanning for all BSs, changing FAs. Particularly, a preamble signal is sent on an inactive FA to support the simultaneous scanning.

In this way, the preamble CINR scanning can be performed continuously without setting any specific scan duration. This obviates the need for exchanging the MOB_SCN_REQ and MOB_SCN_RSP messages between the MS and the serving BS. This preamble CINR scanning of the present invention is referred to as simultaneous scanning. During the simultaneous scanning, the MS separates the preamble signals of the neighbor BSs from a received signal and scans the CINRs of the preamble signal, which is beyond the scope of the present invention and thus will not described herein in more detail. The simultaneous scanning obviates the need for setting any specific scan duration, thereby eliminating the problem of communication disconnection. Therefore, overall system performance is improved.

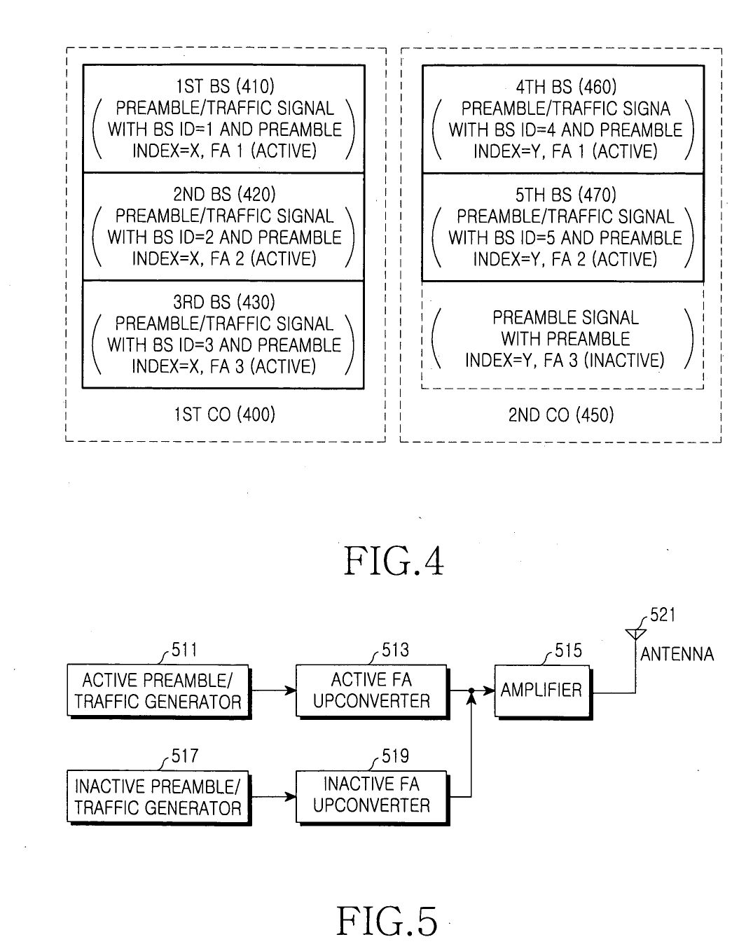

FIG. 4 illustrates an inter-FA handover in an IEEE 802.16e communication system according to an embodiment of the present invention.

Referring to FIG. 4, a first CO 400 uses three FAs, FA 1, FA 2 and FA 3, and a second CO 450 use two FAs, FA 1 and FA 2, with one inactive FA, FA3. FA 1, FA 2 and FA 3 of CO 400 are all in an active state. The active state refers to a state where transmission/reception is normally carried out between a BS and an MS on a corresponding FA. The first and second COs 400 and 450 include a plurality BSs using different FAs at the same geographical location. Specifically, the first CO 400 includes a first BS 410 using FA 1, a second BA 420 using FA 2, and a third BS 430 using FA 3, while the second CO 450 includes a fourth BS 460 using FA 1 and a fifth BS 470 using FA 2. Since the second CO 450 has no BS using FA 3, FA 3 is in inactive state in the second CO 450.

To support the simultaneous scanning, the second CO 450 must send a preamble signal also on FA 3 in the inactive state. In this case, the preamble index of a preamble signal sent on FA 3 is the same as that of a preamble signal on any other active FA in the second CO 450. When a plurality of active FAs exist in the same CO, preamble signals on the FAs may have the same or different preamble indexes. If the preamble indexes are different, the preamble index of a preamble signal sent on an inactive FA is determined to be identical to a randomly selected one of the different preamble indexes. The present invention is described on the assumption that the BSs within the same CO use the same preamble index for operational efficiency. In FIG. 4, the first, second and third BSs 410, 420 and 430 send preamble signals with a preamble index X in the first CO 400, and the fourth and fifth BSs 460 and 470 send preamble signals with a preamble index Y in the second CO 450. The preamble signal on FA 3 in the second CO 450 also has the preamble index Y.

Regarding an inter-FA handover from an MS's point of view, assuming that the third BS 430 is serving the MS, the MS acquires the preamble indexes of neighbor BSs using information about the neighbor BSs included in a MOB_NBR_ADV message broadcast from the third BS 430, and creates a preamble index list with the preamble indexes. The neighbor BS information contains information about the fourth and fifth BSs 460 and 470. Hence, the preamble index list includes the preamble index Y used for the fourth and fifth BSs 460 and 470.

The MS simultaneously scans the preamble signals with the preamble indexes listed in the preamble index list, particularly the CINR of the preamble signal on FA 3 from the second CO 450. If the CINR of the preamble signal on FA 3 from the second CO 450 is equal to or greater than a threshold, the MS makes up a recommended neighbor BS list with the BS IDs of BSs using the preamble index Y. Since the BSs use active FAs, the MS may hand over to the BSs. If m active FAs exists within the same CO and BSs use the same preamble index, n of m BS IDs (1≦n≦m) are selected and listed in the recommended neighbor BS list. With the recommended neighbor BS list, therefore, the MS can perform the handover procedures illustrated in FIGS. 2 and 3.

In the case where the fourth and fifth BSs 460 and 470 and the preamble index of the preamble signal sent on FA 3 from the second CO 450 is a randomly selected preamble index of the fourth and fifth BSs 460 and 470, the preamble index list includes a preamble index which does not require simultaneous scanning. As a result, the MS may perform an unnecessary preamble CINR scanning. That's why the present invention is described on the premise that the BSs within the same CO use the same preamble index.

FIG. 5 is a block diagram of a BS in the IEEE 802.16e communication system according to an embodiment of the present invention.

Referring to FIG. 5, the BS includes an active FA preamble/traffic generator 511, an active FA upconverter 513, an amplifier 515, an inactive FA preamble generator 517, an inactive FA upconverter 519, and an antenna 521. The active FA preamble/traffic generator 511 generates a preamble signal and a traffic signal to be sent on an active FA. The active FA upconverter 513 upconverts the preamble and traffic signals to the active FA. The amplifier 515 amplifies the upconverted signal by a gain and sends the amplified signal through the antenna 521.

The inactive FA preamble/traffic generator 517 generates a preamble signal and a traffic signal to be sent on an inactive FA. The inactive FA upconverter 519 upconverts the preamble and traffic signals to the inactive FA. The amplifier 515 amplifies the upconverted signal by the gain and sends the amplified signal through the antenna 521.

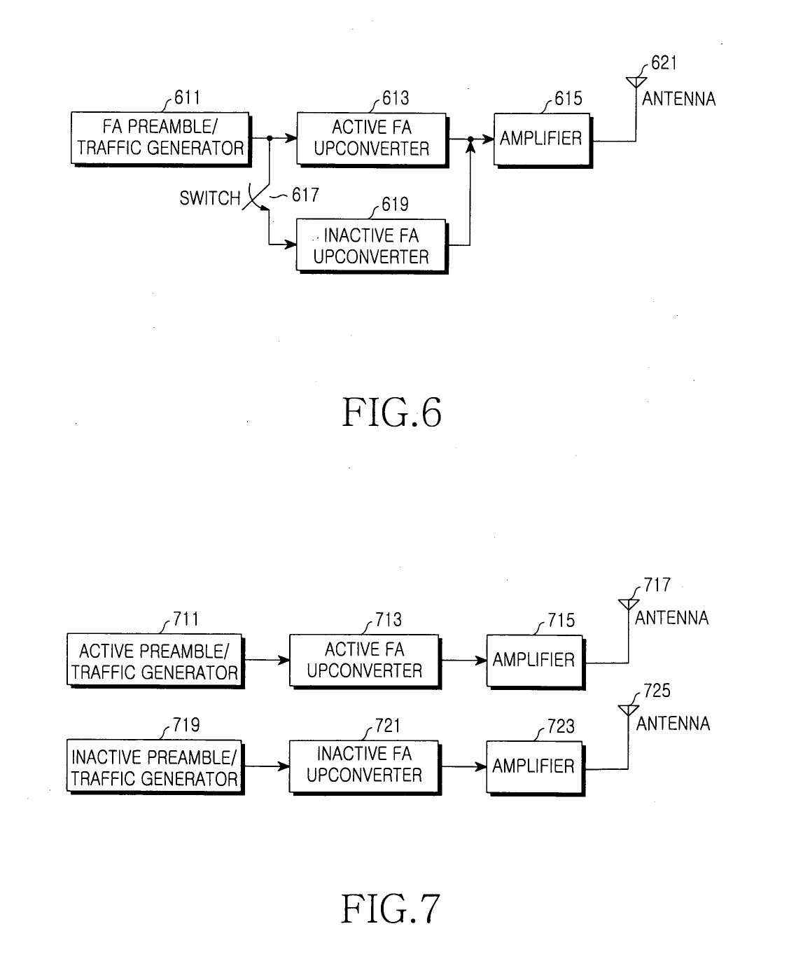

FIG. 6 is a block diagram of a BS in the IEEE 802.16e communication system according to another embodiment of the present invention.

Referring to FIG. 6, the BS of this configuration includes an FA preamble/traffic generator 611, an active FA upconverter 613, an amplifier 615, a switch 617, an inactive FA upconverter 619, and an antenna 621. The FA preamble/traffic generator 611 generates a preamble signal to be sent on an active FA and an inactive FA and a traffic signal to be sent on the active FA, and outputs the preamble and traffic signals for the active FA to the active FA upconverter 613 and the preamble signal for the inactive FA to the switch 617. The active FA upconverter 613 upconverts the preamble and traffic signals to the active FA. The amplifier 615 amplifies the upconverted signal by a gain and sends the amplified signal through the antenna 621.

The switch 617 switches the received preamble signal to the inactive FA upconverter 619. The inactive FA upconverter 619 upconverts the preamble signal to the inactive FA. The amplifier 615 amplifies the upconverted signal by the gain and sends the amplified signal through the antenna 621.

FIG. 7 is a block diagram of a BS in the IEEE 802.16e communication system according to a third embodiment of the present invention.

Referring to FIG. 7, the BS includes an active FA preamble/traffic generator 711, an active FA upconverter 713, an amplifier 715, an antenna 717, an inactive FA preamble generator 719, an inactive FA upconverter 721, a second amplifier 723, and an antenna 725. The active FA preamble/traffic generator 711 generates a preamble signal and a traffic signal to be sent on an active FA. The active FA upconverter 713 upconverts the preamble and traffic signals to the active FA. The amplifier 715 amplifies the upconverted signal by a predetermined gain and sends the amplified signal through the antenna 717.

The inactive FA preamble/traffic generator 719 generates a preamble signal and a traffic signal to be sent on an inactive FA. The inactive FA upconverter 721 upconverts the preamble and traffic signals to the inactive FA. The amplifier 723 amplifies the upconverted signal by a predetermined gain and sends the amplified signal through the antenna 725.

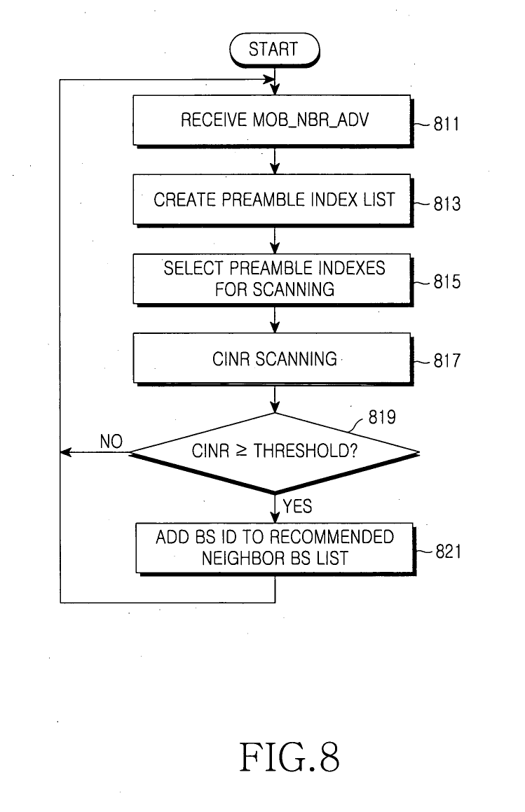

FIG. 8 is a flowchart illustrating an MS operation for performing an inter-FA handover in the IEEE 802.16e communication system according to the present invention.

Referring to FIG. 8, an MS acquires information about neighbor BSs from a MOB_NBR_ADV message broadcast by a serving BS in step 811. In step 813, the MS detects the BS IDs and preamble indexes of the neighbor BSs from the neighbor BS information and creates a preamble index list with the preamble indexes.

The MS selects preamble indexes for CINR scanning from the preamble index list in step 815 and scans the CIRs of preamble signals corresponding to the selected preamble indexes in step 817. In step 819, the MS compares the CINRs with a threshold. For a CINR that is less than the threshold, the MS returns to step 811. For a CINR that is equal to or greater than the threshold, the MS adds the BS ID of a neighbor BS corresponding to the CINR so that the neighbor BS may be selected later as a target BS in step 821 and then returns to step 811.

For simultaneous scanning, a pilot signal may be sent as a reference signal on an inactive FA, instead of a preamble signal. Particularly in the IEEE 802.16e communication system, pilot symbols are always at fixed positions in two Orthogonal Frequency Division Multiple Access (OFDMA) symbols following a preamble and a sequence of pilot symbols can be created simply using a preamble index set in the MOB_NBR_ADV message in the MS. The subsequence operations in the BS and the MS are alike in both cases of using the preamble signal and using the pilot signal as a reference signal. In the latter case, since the pilot signal is sent at a lower power level than the preamble signal, the present invention can be implemented using a relatively small-capacity amplifier.

As described above, the present invention enables an inter-FA handover without setting a specific scanning interval and thus prevents communication disconnection from a serving BS during the handover in an IEEE 802.16e communication system. Consequently, overall system performance is improved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of performing an inter-frequency assignment (FA) handover in a mobile station (MS) in a communication system, comprising the steps of:
receiving neighbor base station (BS) information from a serving BS, the neighbor BS information including a BS ID of at least one neighbor BS and a reference signal index of a reference signal used in the at least one neighbor BS;
scanning the reference signal corresponding to the reference signal index when the reference signal from the at least one neighbor BS is to be scanned; and
selecting the BS ID of the at least one neighbor BS using the reference signal index as a BS ID for a recommended neighbor BS available for the inter-FA handover, if the scanned reference signal has a quality equal to or greater than a threshold.

2. The method of claim 1, wherein the at least one neighbor BS has the same reference signal index within the same central office.

3. A method of performing an inter-frequency assignment (FA) handover in a central office in a communication system, comprising the steps of:
broadcasting from a serving base station (BS) neighbor BS information including a BS ID of at least one neighbor BS using at least one active FA and a reference signal index of a reference signal used in the at least one neighbor BS; and
sending from the serving BS a reference signal with the reference signal index on the active FA and a reference signal with the reference signal index on at least one inactive FA.

4. The method of claim 3, wherein when a BS using the active FA and a BS using the inactive FA are located within the same central office, the BSs have the same reference signal index.

5. A method of performing an inter-frequency assignment (FA) handover in a communication system, comprising the steps of:
broadcasting from a serving base station (BS) neighbor BS information including a BS ID of at least one neighbor BS using at least one active FA and a reference signal index of a reference signal used in the at least one neighbor BS, sending from the serving BS a reference signal with the reference signal index on the active FA and a reference signal with the reference signal index on at least one inactive FA by a central office;
receiving the neighbor BS information from the serving BS by a mobile station (MS);
scanning the reference signal corresponding to the reference signal index when the reference signal from the at least one neighbor BS is to be scanned by the MS; and
selecting the BS ID of the at least one neighbor BS using the reference signal index as a BS ID for a recommended neighbor BS available for the inter-FA handover, if the scanned reference signal has a quality equal to or greater than a threshold.

6. The method of claim 5, wherein the at least one neighbor BS has the same reference signal index within the same central office.

7. A system for performing an inter-frequency assignment (FA) handover in a communication system, comprising:
a mobile station (MS);
a serving base station (BS);
at least one neighbor BS using at least one active FA; and
a central office,
wherein the central office controls the serving BS to broadcast neighbor BS information including a BS ID of the at least one neighbor BS and a reference signal index of a reference signal used in the at least one neighbor BS, and controls the serving BS to send a reference signal with the reference signal index on the active FA, and send a reference signal with the reference signal index on at least one inactive FA.

8. The system of claim 7, wherein the MS receives the neighbor BS information from the serving BS, scans the reference signal corresponding to the reference signal index when the reference signal from the at least one neighbor BS is to be scanned, and determines the BS ID of the at least one neighbor BS using the reference signal index as a BS ID for a recommended neighbor BS available for the inter-FA handover, if the scanned reference signal has a quality equal to or greater than a threshold.

9. The system of claim 8, wherein the at least one neighbor BS has the same reference signal index within the same central office.
